(19) United States
(12) Patent Application Publication
(10) Pub. No.: US 2003/0133868 A1
(43) Pub. Date: Jul. 17, 2003

(54) Mesostructured metal or non-metal oxides and method for making same

(76) Inventors: Laurent Bonneviot, Lyon (FR); Michel Morin, Quebec (CA); Alizera Badiel, Tehran (IR)

Correspondence Address: FOLEY AND LARDNER, SUITE 500, 3000 K STREET NW, WASHINGTON, DC, 20007, US

(21) Appl. No.: 10/182,253

(22) PCT Filed: Jan. 29, 2001
(86) PCT No.: PCT/CA01/00062

(30) Foreign Application Priority Data
Jan. 27, 2000 (CA) 297555

(51) Int. Cl. C01B 33/12

(52) U.S. Cl. 423/592.1; 423/335

(57) ABSTRACT

The invention relates to a process for producing mesostructured metal or non-metal oxides. The process is essentially characterized in that it consists in: (a) mixing in a liquid reaction medium a surfactant and a metal or non-metal oxide at temperature enabling the surfactant to be dissolved in the reaction medium, the surfactant/metal or non-metal oxide molar ratio being less than 1; (b) heating the reaction medium at a temperature sufficiently high and for a sufficient period of time to permit structural reorganization of the metal or non-metal oxide and to obtain a mesostructured metal or non-metal oxide; and (c) effecting a liquid-solid separation of the reaction medium to recover the mesostructured metal or non-metal oxide. The use of a surfactant/metal or non-metal oxide molar ratio less than 1 enables to avoid froth or bubble formation which greatly hinders any subsequent leaching. Thus almost all the surfactant is consumed in the production of mesostructured metal or non-metal oxides, and excess silica can easily be removed and recycled.

### TECHNICAL FIELD

The present invention relates to new mesostructured metal or non-metal oxides as well as to a process for producing same. More particularly, the invention is directed to new mesostructured silica materials and to a process for their production.

### BACKGROUND ART

Current processes for the production of mesostructured silicas, starting from a surfactant and silica, use a surfactant: silica stoichiometry of 1:1. In an alternative, an excess surfactant is present during production. Since the surfactant is a very expensive compound, it follows that the products obtained by conventional processes are costly.

Purification, storage and transformation of chemical products are involved in all industrial chemical processes. They use the principles of diffusion, separation, adsorption and surface reactions involving porous solids. A large pore volume is necessary for adsorption capacity, while a large developed surface promotes separation properties and catalytic reactivity. The search for new solid materials which have a large internal volume, a specific surface greater than 300 m²/g and a regular porosity in the nanometric range constitutes a new emerging area, that of mesoporous molecular sieves.

Zeolites which have the type of characteristics mentioned above in the microporous range (smaller pores, vide infra) are used in the various steps for the production of certain chemical products. These zeolites are crystallized aluminosilicates used in petroleum cracking and other refining processes. Zeolites are also used in many other catalytic processes, including decontamination processes. They are also used as adsorbent, desiccant and purifier, in particular for gases. Their internal volume is typically of the order of 0.1 to 0.3 cm³ per gram for a surface of the order of 500 m²/g. The size of the pores varies from 1.5 to 0.4 nm according to their crystalline structure. Only small molecules can enter, which results in that they act as microporous molecular sieves. Thus, one conceives their application as catalyst in the synthesis of light gasoline, in petroleum refining and as desiccant and molecular filter for the purification of gases. Their thermal stability permits recycling and, moreover, they are nontoxic. However, when it is desired to treat larger molecules coming from tars, for example, or molecules useful in fine chemistry, such as polysubstituted aromatic molecules, polyaromatic molecules, molecules with medicinal properties, etc., zeolites are inactive. It is then necessary to use oxides called mesoporous oxides that have cavities with a size greater than 1.5 nm. In this pore size range, materials have existed for a long time, such as activated carbons, silicas, aluminas, aluminasilicas and oxides of magnesium, titanium, and zirconium, etc. These oxides have characteristics of lesser interest than zeolites, i.e., a pore volume less than 0.05 cm³/g, a specific surface which is most frequently less than 100 m²/g and a broad pore size distribution. Silicas have the best characteristics in this group of oxides. Typically, they have surfaces and pore volumes similar to those of zeolites, but without reaching the properties of molecular sieves because of their broad pore size distribution, varying from 2 to 8 nm. They are used in separation, particularly in organic synthesis. The new mesostructured oxides obtained from surfactant molecules have the characteristics of much higher specific surface (>300 m²/g) and a very narrow pore size distribution, as zeolites do. These oxides permits “selection” of molecules with sizes varying from 1 to 100 nm and therefore they are called mesoporous molecular sieves.

The first inroad into the field of mesoporous molecular sieves is attributed to the Japanese, who announced the synthesis of FSM-16 in 1990. This material is obtained by basic treatment of kanemite (lamellar sodium silicate) in the presence of cetyltrimethylammonium chloride. X-ray diffraction reveals that the structure is hexagonal. Electron microscopy confirms the symmetry by demonstrating a very regular honeycomb structure formed by monodimensional channels with an internal diameter of approximately 3.0 nm and a wall thickness from 0.7 to 1.0 nm. Calcining at 500-600° C. does not destroy this spatial arrangement and permits liberation of the interior of the channels by combustion of surfactant molecules. The mean pore diameter defines a particularly narrow pore distribution (3.0±0.5 nm).

### DISCLOSURE OF THE INVENTION

The invention relates to a new process for the production of mesostructured metal or non-metal oxides. The process according to the invention is essentially characterized in that it comprises the following steps:

a) mixing a surfactant and a metal or non-metal oxide mixed in a liquid reaction medium at a temperature that permits dissolution of the surfactant in the reaction medium, the molar ratio of surfactant: metal or non-metal oxide being less than 1;

b) heating the reaction medium at a sufficiently high temperature and for a sufficient period of time to permit structural reorganization of the metal or non-metal oxide and to obtain a mesostructured metal or non-metal oxide; and

c) effecting a liquid-solid separation of the reaction medium is performed to recover the mesostructured metal or non-metal oxide.

The use of a surfactant: metal or non-metal oxide ratio less than 1 permits avoidance of the formation of foam or bubbles which interfere considerably with subsequent washing. Almost all of the surfactant is thus consumed in the production of the mesostructured metal or non-metal oxide, and the excess silica can be easily removed and recycled subsequently.

The invention also relates to with the metal oxide or non-metal oxide obtained by a process as defined above.

### MODES OF CARRYING OUT THE INVENTION

According to a preferred embodiment of the invention, the operation begins with a non-metal oxide consisting of silica, and an aqueous and basic reaction medium is used.

Preferably, the surfactant is a cationic surfactant having an organic anion. For example, one can use quaternary ammonium, quaternary phosphonium or quaternary sulfonium having an alkyl chain with 6 to 32 carbon atoms, preferably 10 to 14 carbon atoms, or an aromatic nucleus having to 10 carbon atoms, such as a phenyl or benzyl nucleus. The organic anion is advantageously a carboxylate, phosphonate or sulfonate anion. The presence of organic anions allows a decrease of the critical micelle concentration in comparison to inorganic cations. The direct consequence of this phenomenon is the possibility of using very low concentrations of surfactant. Thus, one can use a molar ratio of surfactant: silica smaller than the normal stoichiometry, permitting almost total consumption of the surfactant. Typically, the surfactant silica molar ratio is between 0.2 and 0.00001, preferably between 0.1 and 0.01.

The almost total consumption of the surfactant results in a very low surfactant concentration in the supernatant, thus avoiding the formation of foam and facilitating the elimination of excess silica using filtration or aspiration from above the solid. The method also permits recovery of the surfactant, which is by far the most expensive compound in the synthesis process. Moreover, the silica used as starting material can be quite inexpensive, so that the cost of production is even more diminished. The process thus permits solving the problems associated with the formation of foam by the surfactant, and avoidance of an additional step in order to increase the stability of the mesostructured silica.

The carboxylate, phosphonate and sulfonate anions preferably have a saturated or unsaturated alkyl chain having 1 to 10 carbon atoms or an aromatic nucleus having 5 to 10 carbon atoms. Each of these anions may optionally be grafted with functional groups, such as an α-hydroxo or α-amino acid group.

The preferred carboxylate anions are those comprising a benzoate or benzylate anion and their derivatives which have substituents on the aromatic nucleus. The preferred sulfonate anions comprise an aromatic function, such as a tosylate or a benzylsulfonate, as well as their derivatives having one or more substituents on the aromatic nucleus. The preferred phosphonate anions comprise an aromatic function, such as a benzenephosphonate or benzylphosphonate, as well as their derivatives having one or more substituents on the aromatic nucleus. In each of these cases, the substituents on the aromatic nucleus comprise an alkyl chain, alkoxy, hydroxy, a halogen or a combination thereof.

The silica used as starting material may come from different origins, such as a silica solution, an alkoxysilicon comprising 1 to 6 carbon atoms, a silicon halide such as silicon tetrachloride, etc. Preferably, a sodium, lithium, potassium, rubidium or cesium silicate solution is used.

According to a preferred aspect of the process according to the invention, step (a) is carried out at a temperature between 20 and 90° C. This step can be carried out under mechanical agitation or under agitation by ultrasound treatment for a period varying between 1 minute and 10 hours, preferably between 15 minutes and 1 hour. On the other hand, step (b) is preferably carried out at a temperature between 40 and 160° C. for a time period varying between 15 minutes and 10 hours, preferably between 30 minutes and 2 hours. This heat treatment can be carried out by refluxing the water of the reaction medium, preferably in an autoclave. Step (b) permits a structural reorganization of the initial silica and production of a mesostructured silica.

After elimination of the supernatant by liquid-solid separation, followed by washing with water, the mesostructured silica has an XRD spectrum having at least 3 characteristic peaks between 1 and 4° 2θ followed by 2 other distinct peaks. A fourth peak is sometimes visible. This configuration is typical for a Pm6m hexagonal symmetry, with a long-range order in the interval from 1 to 10 nm. After calcining at 540° C., the position of each XRD peak characterizing the solid obtained is approximately the same as before calcining at 540° C., which indicates that there is neither shrinkage nor dilatation of the mesoporous structure.

The steps of the process according to the invention permits at the end of the process a partial extraction of surfactant molecules, producing a material which is ultrastable in water. One of the treatments is of the hydrothermal type, while another is of the chemical type (direct functionalization). This latter type of transformation permits grafting of transition metals, alkali metals or alkaline-earth metals, providing the solid with oxidizing-reducing or acid-basic properties that are useful in catalysis. The mesostructured silica can also be subjected to calcining to remove all traces of the surfactant.

The mesostructured siliceous materials of the present invention have a narrow pore size distribution and do not have a double pore distribution. The molecular control of the pore diameter of the mesostructured silica is carried out by using surfactants that have a variable alkyl chain length, that is, between 6 and 32 carbon atoms, preferably 10 and 24 carbon atoms, in order to obtain an effective variation of the pore size in the interval varying between 1.5 and 4.4 nm of internal diameter, while maintaining a long range order in the structure.

The process according to the invention is compatible with the use of auxiliary hydrophobic molecules, that is, benzene, toluene, mesitylene, etc. Their addition during the synthesis process is desirable in order to make the surfactant micelles swell and to increase the pore diameter up to 10 nm.

The mesostructured siliceous materials of the present invention have the structural characteristics of mesoporous molecular sieves and differ from the known materials, primarily by the chemical composition of the liquid crystal which forms them and secondly by the chemical nature of their surface, defined among others by the density of hydroxyl groups. The particle size of the silicas is of the order of a micron and their pore diameter is of the order of nanometer with a very narrow size distribution (±0.5 nm). The spatial arrangement of the channels is sufficiently regular to create a periodicity on the nanometric scale, characterized by X-ray diffraction angles less than 5°.

Moreover, the mesostructured silica of the present invention, in addition to being very stable, have after washing with water a low surface density of silanolates. The concentration measured by acid-base titration gives a silanolate:silicon ratio greater than 16 for a mesoporous structure obtained by a conventional process, while this ratio is 13 for the present mesostructured silica. Parallel to this, the thickness of the wall controlling the silicon surface bulk silicon ratio is not higher. These results show that the silanol density at the surface is lower for the mesostructured silica obtained by the process according to the present invention than for the mesoporous silica obtained according to the conventional methods.

The experimental results obtained show that the mesostructured silica of the present invention retains its structure after calcining up to 820° C. for several hours, or even upon boiling in water for 48 hours, contrary to the mesoporous silicas obtained by conventional methods.

Once its production is completed, the mesostructured silica of the present invention can be treated in an autoclave in the presence of water at temperatures varying between 70 and 150° C. for 15 minutes up to 1 week, without its structure becoming altered. Moreover, according to the XRD spectrum obtained, the resistance to solidification in air is increased up to 920° C. for several hours. The mesostructured silica can also be washed with an acidic ethanol solution to remove the solvent before calcining without damaging the structure. Such an acid washing permits removal of almost all the surfactant which can then be recycled. Preferably, the acid washing is carried out with conjugate acid of the counter-ion of the surfactant. This permits regeneration of the salt of the surfactant used in the process, which can then be recycled. For example, a carboxylic acid may regenerate the carboxylate of the surfactant while the paratoluenesulfonic acid may regenerate the tosylate. The acid washing preserves the stability of the mesostructured silica. Actually, the structure of this latter dilates slightly, but this dilatation is reversed by dehydration or calcining. Such properties cannot be found in the mesoporous silicas obtained by conventional methods.

The mesostructured silica of the present invention can be modified by using a series of well-known reactions in the field of the surface chemistry of silanols. The hydrophobicity of the surface is adjusted by using the silylation technique with trialkyls. A high degree of silylation can be obtained by utilization of an anhydrous solution of a halotrialkylsilane, which can be combined with a corresponding hexamethyldisiloxane. For example, silylation by trimethyl is carried out by using chlorotetramethylsilane alone or in combination with hexamethyldisiloxane. The silylation can be completed either after the calcining or the acid treatment or directly on the nonsynthesized form still containing the surfactant. The selection of the silylation agent permits adjustment of the hydrophobicity as well as of the organic affinity. The alkylsilylated mesoporous silica is particularly resistant to pressures as high as 5 t/cm², that is, 5000 atmospheres. It can therefore be used for the recovery of petroleum waste from water at high depth, for example.

The mesostructured silica of the present invention is characterized by a nitrogen isotherm of type IV, which is characteristic for mesoporous materials having a narrow pore size distribution. The available surfaces is typically of the order of 800-1300 m/g² and the pore volume is large. The nitrogen isotherms show that 0.4 to 0.7 STP liters of nitrogen per gram of mesostructured silica are condensed in the liquid form at temperatures close to that of the liquefaction of nitrogen (STP=volume of gas measured at 25° C. and 1 atmosphere). Thus, the present mesostructured silica can be used to separate molecules with a size varying between 1.5 and 10 nm.

The high available surface, the good thermal and hydrothermal stability, the filtration properties and the possibility of adjustment of the surface affinity thus make the present mesostructured silica particularly advantageous in chromatography. Moreover, the size of the pores can be adjusted specifically for exclusion chromatography. The mesostructured silica can also be used as a means of separation for chemical analyses or even in organic synthesis. It may also be used, after appropriate treatment, for the absorption of hydrocarbons or of hydrophilic molecules, for selective absorption of polar solvents, such as water, alcohols, acetonitrile, etc., and also for the absorption of hydrophilic molecules while repelling hydrophobic molecules.

Organic ligands, such as amines, polyamines or thiols are useful for converting mesostructured silica into selective absorbents for transition metals and heavy metals in the treatment of environmental waste. Metals such as chromium, mercury, cadmium, lead, americium, uranium, thorium and plutonium are good examples. The recovery of precious metals, such as gold, palladium, silver, platinum with the aid of such a silica can also be contemplated.

Good stability and relatively low manufacturing cost are two important elements in the utilization of the present mesostructured silica in the field of heterogeneous catalysis, particularly in petroleum refining. The addition of aluminum, either during the manufacturing process or subsequently, in a proportion of 1-10%, permits utilization of the mesostructured silica obtained in petroleum cracking, without loss of stability.

An aluminum salt that permits the dissolution of aluminum in water represents an advantageous source of aluminum for the purpose in hand. When aluminum is added after the mesostructured silica had been produced, it is preferable to use a hydrolyzable precursor which reacts with the silanol groups on the pore wall. Naturally, other metals can also be added to the mesoporous silica.

The following examples are provided to illustrate certain embodiments of the invention, and should not be considered at all as a limitation of their scope.

### EXAMPLE 1

1.252 g of cetyltrimethylammonium p-toluenesulfonate are added to 43.5 g of water. The mixture is heated slowly for a few minutes at 50° C. until the dissolution of the cetyltrimethylammonium para-toluenesulfonate. Then 34.7 g of a silicate solution (8.9 weight % SiO₂) are added dropwise. The mixture has the following molar composition (per mole of SiO₂):

100 moles of SiO₂,

50.6 moles of NaOH,

5.4 moles of cetyltrimethylammonium para-toluenesulfonate, and

7991 moles of H₂O.

The resulting mixture is agitated in a bath at 50° C. for 2 hours. The gel obtained is placed in a 250 ml autoclave and is heated at 130° C. for about 24 hours. The mixture is then cooled to room temperature and 250 ml of distilled water are added, and the mixture is agitated. The mixture is filtered, washed again with 50 ml of distilled water, and dried in air. The final product can be calcined at 550° C. in air for 8 hours. The gel has a concentration of 57 weight % of SiO₂.

The X-ray diffraction spectrum shows one peak of high relative intensity at 46.0±2.0 Å and weak peaks at 26.3±1.0 Å, 22.7±1.0 Å and 5.1±1.0 Å. The XRD spectrum shows 4 peaks corresponding to a hexagonal arrangement of high quality having a d₁₀₀ of approximately 46 Å.

The calcined product of this example has an evolute surface of 1247 m²/g and a pore size of 26.9 nm diameter (according to the BJH method). These values permit one to obtain a wall thickness of 6.5 Å. The nitrogen absorption-desorption curves at 77 K show that there is no microporosity. A shoulder at 0.33 P/P₀ is present, which is characteristic of a mesopore possessing a typical hysteresis.

### EXAMPLE 2

The procedure of Example 1 is repeated and the characteristics of the product obtained are shown in Table 1 hereinbelow.

### EXAMPLE 3

500 mg of the product obtained in Example 2 are mixed with 8 g of water. The mixture is placed in a 250 ml autoclave and heated to 100° C. After 24 hours, the mixture is filtered and the solid is dried in air. The spacing d of the first diffraction spectrum for the product before and after calcining is provided in Table 1 hereinbelow.

### EXAMPLE 4

500 mg of the product obtained in Example 2 are mixed with 5.5 g of water. The mixture is placed into a 250 ml autoclave and heated at 130° C. After 24 hours, the mixture is filtered and the solid is dried in air. The characteristics of the product obtained appear in Table 1 below.

TABLE 1

| | | | spacing d | spacing d |
|---|---|---|---|---|
| | | | (Å) | (Å) |
| | | SiO/SiO₂ | (before | (after |
| Example | SiO₂ (wt. %) | (molar ratio) | calcining) | calcining) |
| 1 | 55.0 | 14 | 43.3 | 40.5 |
| 2 | 54.6 | — | 42.9 | 38.4 |
| 3 | 57.2 | 14 | 42.0 | 42.0 |
| 4 | 55.5 | 30 | 42.0 | 42.0 |

The examples mentioned above illustrate the stability of the mesostructured silicas at high temperatures.

1. Process for the production of a mesostructured metal or non-metal oxide, characterized in that it comprises the following steps:
a) mixing a surfactant and a metal or non-metal oxide mixed in a liquid reaction medium at a temperature that permits dissolution of the surfactant in the reaction medium, the molar ratio of surfactant: metal or non-metal oxide being less than 1;
b) heating the reaction medium at a sufficiently high temperature and for a sufficient period of time to permit structural reorganization of the metal or non-metal oxide and to obtain a mesostructured metal or non-metal oxide; and
c) effecting a liquid-solid separation of the reaction medium is performed to recover the mesostructured metal or non-metal oxide.

2. Process according to claim 1, characterized in that one operates starting from a non-metal oxide.

3. Process according to claim 2, characterized in that one operates starting from silica.

4. Process according to claim 3, characterized in that that the reaction medium is aqueous and basic.

5. Process according to claim 3, characterized in that the surfactant is a cationic surfactant having an organic anion.

6. Process according to claim 5, characterized in that the cationic surfactant is a quaternary ammonium, a quaternary phosphonium or a quaternary sulfonium salt having an alkyl chain with 6 to 32 carbon atoms or an aromatic nucleus having 5 to 10 carbon atoms.

7. Process according to claim 5, characterized in that the organic anion is a carboxylate, phosphonate or sulfonate anion.

8. Process according to claim 7, characterized in that the organic anion comprises an alkyl chain having 1 to 10 carbon atoms or an aromatic nucleus having 5 to 10 carbon atoms.

9. Process according to claim 1, characterized in that step (a) is carried out under agitation with an ultrasound treatment.

10. Process according to claim 1, characterized in that step (a) is carried out at a temperature between 20 and 90° C.

11. Process according to claim 1, characterized in that step (b) is carried out at a temperature between 40 and 160° C.

12. Process according to claim 1, characterized in that the mesostructured metal or non-metal oxide obtained in step (c) is subjected to calcining to remove all traces of surfactant.

13. Mesostructured metal or non-metal oxide obtained by a process as defined in claim 1.

14. Mesostructured silica obtained by a process as defined in claim 3.
